(19) United States
(12) Patent Application Publication
(10) Pub. No.: US 2024/0330466 A1
(43) Pub. Date: Oct. 3, 2024

(54) METHODS AND APPARATUS TO VERIFY THE INTEGRITY OF A MODEL

(71) Applicant: Intel Corporation, Santa Clara, CA (US)

(72) Inventors: Scott Douglas Constable, Portland, OR (US); Marcin Andrzej Chrapek, Zurich (CH); Marcin Spoczynski, Hillsboro, OR (US); Cory Cornelius, Portland, OR (US); Mona Vij, Hillsboro, OR (US); Anjo Lucas Vahldiek-Oberwagner, Berlin (DE)

(21) Appl. No.: 18/676,413

(22) Filed: May 28, 2024

(51) Int. Cl. G06F 21/57

(52) U.S. Cl. CPC G06F 21/57

(57) ABSTRACT

Methods, apparatus, systems, and articles of manufacture to verify integrity of a model are disclosed. An example apparatus includes programmable circuitry to initialize an instance of a trusted execution environment; upload a security manifest of the trusted execution environment and a machine learning model; determine whether to store the machine learning model into a memory based on checking of the security manifest; determine whether the machine learning model is valid; and output a validation result.

### BACKGROUND

In recent years, artificial intelligence (e.g., machine learning, deep learning, etc.) has increased in popularity. Artificial intelligence may be implemented using neural networks. Neural networks are computing systems inspired by the neural networks of human brains. A neural network can receive an input and generate an output. The neural network includes layers of neurons corresponding to weights that can be trained (e.g., can learn, be weighted, etc.) based on feedback so that the output corresponds to a desired result. Once the weights are trained, the neural network can generate an output based on an input. Neural networks are used for the emerging fields of artificial intelligence and/or machine learning. A large language model (LLM) is a type of artificial neural network with the ability to achieve general-purpose language generation and other natural language processing tasks. An LLM can generate text, predict a subsequent text based on input text, etc.

### BRIEF DESCRIPTION OF THE DRAWINGS

FIG. 1 is a system diagram of devices that verify the integrity of an AI-based model.

FIG. 2 is a block diagram of an example implementation of the integrity checking circuitry of FIG. 1.

FIG. 3 is a block diagram of an example implementation of the model evaluation circuitry of FIG. 1.

FIG. 4 is a block diagram of an example implementation of the model verification circuitry of FIG. 1.

FIG. 5 is a flowchart representative of example machine-readable instructions and/or operations that may be executed, instantiated, and/or performed by programmable circuitry to implement the integrity checking circuitry of FIG. 2.

FIG. 6 is a flowchart representative of example machine-readable instructions and/or operations that may be executed, instantiated, and/or performed by programmable circuitry to implement the integrity checking circuitry of FIG. 2.

FIG. 7 is a flowchart representative of example machine-readable instructions and/or operations that may be executed, instantiated, and/or performed by programmable circuitry to implement the model evaluation circuitry of FIG. 3.

FIG. 8 is a flowchart representative of example machine-readable instructions and/or operations that may be executed, instantiated, and/or performed by programmable circuitry to implement the model verification circuitry of FIG. 4.

FIG. 9 is a block diagram of an example processor platform including programmable circuitry structured to execute, instantiate, and/or perform the computer readable instructions and/or perform the example operations of FIGS. 5-7 to implement at least one of the integrity checking circuitry, and/or the model evaluation circuitry of FIGS. 1-3.

FIG. 10 is a block diagram of an example processor platform including programmable circuitry structured to execute, instantiate, and/or perform the computer readable instructions and/or perform the example operations of FIG. 8 to implement the model verification circuitry of FIGS. 1 and/or 4.

FIG. 11 is a block diagram of an example implementation of the programmable circuitry of FIGS. 9 and/or 10.

FIG. 12 is a block diagram of another example implementation of the programmable circuitry of FIGS. 9 and/or 10.

FIG. 13 is a block diagram of an example software/firmware/instructions distribution platform (e.g., one or more servers) to distribute software, instructions, and/or firmware (e.g., corresponding to the example machine-readable instructions of FIGS. 9 and/or 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Artificial intelligence (AI)-based models, such as machine learning models, deep learning models, neural networks, deep neural networks, etc. are used to perform a task (e.g., classify data). An AI-based model may be trained using data (e.g., unlabeled data or data correctly labelled with a particular classification). Training a traditional AI-model adjusts the weights of neurons of the neural network. After an AI-based model is trained, the AI-based model can be deployed for use. Data can be input into the deployed neural network and the weights of the neurons are applied (e.g., multiplied and accumulate (MAC)) to input data to be able to process the input data to perform a function (e.g., classify data, generate text, etc.).

In some examples, a model may be deployed to a cloud service provider or other entity that can distribute the trained model to various devices. However, after the model is deployed to the cloud service provider, an attacker can tamper with the model so that the model that is distributed to the implementing devices is not the same as the trained model. Accordingly, some systems protect AI-based models using encryption and/or hashing protocols to prevent an attacker from altering a deployed model before it implemented in a trusted execution environment of an implementing device. In this manner, the TEE in the implementing device can decrypt and/or hash a received model to ensure that the deployed model is the same model that was trained and has not been tampered with.

However, as AI-based models become more complex to perform more complex tasks, the size of the AI-based model increases. For example, some LLMs can have billions or trillions of parameters. Thus, the model files that include the weights of a trained LLM or other AI-based model can exceed terabytes of data. Accordingly, the number of resources, overhead, and/or time needed to hash such large models is significant. Examples disclosed herein are used to verify the integrity of an AI-based model without the use of a cryptographic hash of the entire AI-based model, thereby reducing the resources, overhead, and/or time needed to hash AI-based models.

Examples disclosed herein include an offline model evaluation phase and an online model verification phase. The offline model evaluation phase includes generating a set of input values that, when applied to a trained AI-based model, activate (e.g., excite) more than a threshold number of neurons of the model. Examples disclosed herein further generate an input output list (e.g., a group, a collection, an array, etc.) by linking the input values to the corresponding output values generated by the AI-based model when the inputs were applied. The input output list can be encrypted and provided to any implementing device when the model is implemented in a TEE of the implementing device. The input generated during the offline model evaluation phase are herein referred to as reference input values and the output values generated during the offline model evaluation phase are herein referred to as reference output values.

During the online verification phase, the implementing device can decrypt the input output list to identify the reference input values and corresponding reference output values. The implementing device can apply the reference input values as inputs to an obtained model to generate online output values. The implementing device can then compare the online output values to the corresponding reference output values to see if the values match. If the values match, the implementing device establishes the integrity of the AI-based model with high probability. If the values do not match, the implementing device determines that the AI-based model is invalid and/or untrustworthy (e.g., has been tampered with after the offline phase was complete).

Additionally, examples disclosed herein perform layer-specific probing to enhance AI-based model integrity checking. Layer-specific probing is a technique that verifies the integrity of individual layers within an AI-based model. As described above, AI-based models may include a number of layers of nodes. An input is applied to one layer and an output value of a layer (e.g., an activation) is output by the layer. By focusing on individual layers, examples disclosed herein verify the integrity of each layer independently to ensure no part of the model is overlooked when verifying integrity (e.g., to ensure that each layer is working as intended).

The example layer-specific probing technique described herein increases the activation of chosen neurons and/or layers while decreasing activation of other neurons and/or layers based on a gradient of activations in specific layers with respect to an input to identify inputs that significantly influence the specific layers to increase efficiency of the probing process. Examples disclosed herein provide a granular approach to verifying the integrating of AI-based models. Also, by focusing on individual layers and ensuring proper function at a layer level, examples disclosed herein provide a more confident and reliable approach to determining the integrity of an AI-based model.

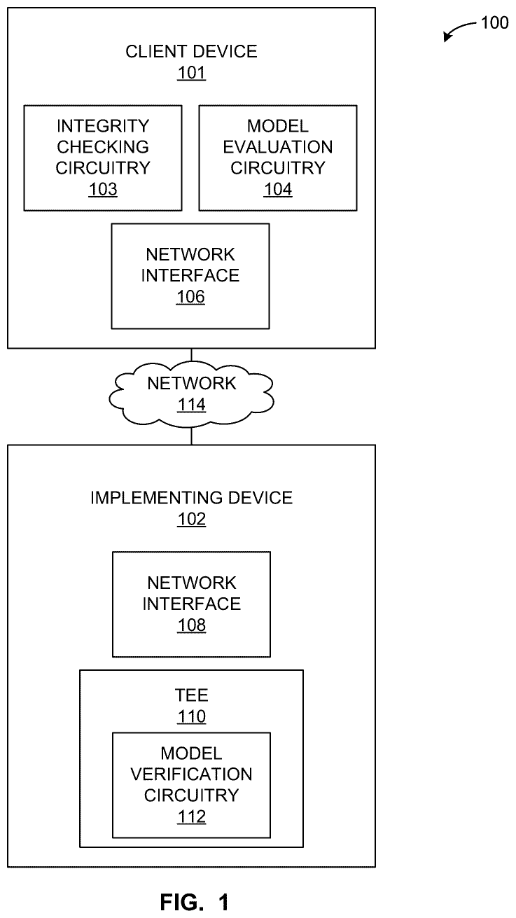

FIG. 1 is an example environment 100 that includes an example client device 101 and an example implementing device 102 to verify the integrity of an AI-based model. The example client device 101 includes example integrity checking circuitry 103, example model evaluation circuitry 104, and an example network interface 106. The example implementing device 102 includes an example network interface 108 and an example TEE 100, which includes example verification circuitry 112. FIG. 1 further includes an example network 114. In some examples, the client device 101 and the implementing device 102 may be implemented by the same device. In such examples, the device will include the integrity checking circuitry 103, the model evaluation circuitry 104, the network interface 106, 108, the TEE 110, and the model verification circuitry 112.

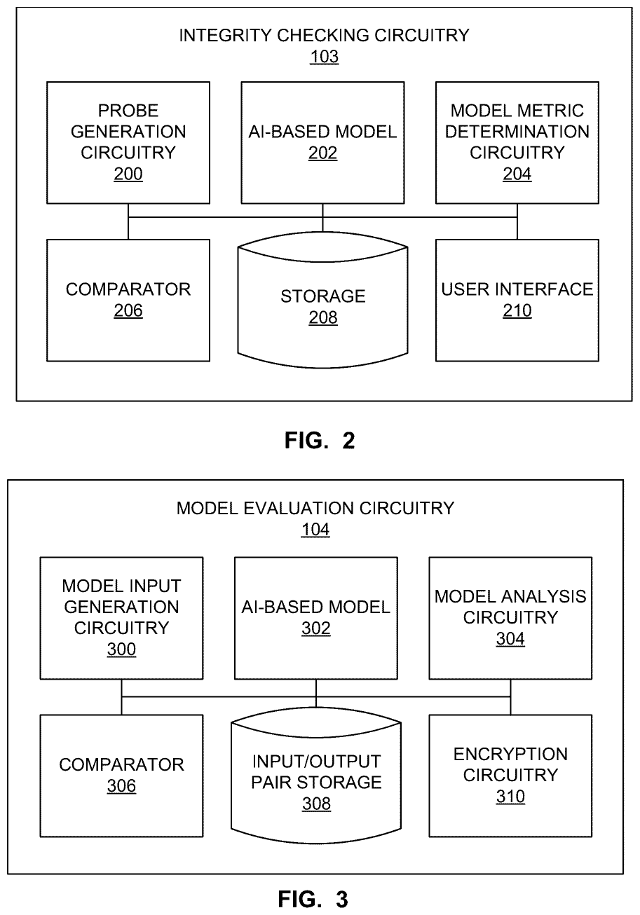

The client device 101 of FIG. 1 is a computing device (e.g., a computer, a server, etc.). The client device 101 includes the integrity checking circuitry 103 to perform a layer-based probing protocol to verify the integrity of a trained model before deployment. The integrity checking circuitry 103 applies inputs to one or more layers of an AI-based model and uses information about the AI-based model and the activation value(s) output by the one or more layers to generate a layer integrity score. If the integrity checking circuitry 103 determines that the layer integrity score of any of the layers of the AI-based model is below a threshold, the integrity checking circuitry 103 tags the AI-based model as including an anomaly. In this manner, a user can update and/or retrain the model to eliminate the anomaly and/or increase the layer integrity score. The threshold may be based on user and/or manufacturer preferences. In some examples, the threshold is based on a percentage of the total number of neurons (e.g., 90%, 95%, 99%, or 100% of the total number of neurons of the AI-based model). The threshold may be obtained from a user and/or administrator via a function call in an API, via a user interface, etc. In some examples, the threshold may be obtained from another device or another component of the same device via interface circuitry. The integrity checking circuitry 103 is further described below in conjunction with FIG. 2.

The model evaluation circuitry 104 of FIG. 1 evaluates a trained model to generate an input output pair list that can be used after deployment to verify the integrity of a deployed model (e.g., to ensure that the model has not been tampered with after evaluation or after being evaluated. The trained model may be trained at the client device 101 or may be obtained from another device (e.g., via the network interface 106). The model evaluation circuitry 104 performs an offline protocol to determine a set of inputs that, when applied to a model, excite or activate a threshold number of neurons of the model. The corresponding outputs to the set of inputs are linked to the respective inputs to generate an input output list that can be used as a reference to verify the integrity of a deployed model, as further described below in conjunction with the model verification circuitry 112. The model evaluation circuitry 104 can encrypt the input output pairs and provide the encrypted input output pairs to the implementing device 102 via the network (e.g., using the network interface 106). In some examples, the input output pairs may not be encrypted. Rather, encryption may automatically occur at the transport network layer (e.g., via a transport layer security (TLS)) of the implementing device 102. The model evaluation circuitry 104 is further described below in conjunction with FIG. 3.

The network interface 106 of FIG. 1 receives and/or transmits data to/from the implementing device 102 and/or any other device via the network 114. For example, the network interface 106 may transmit a trained model data to a cloud-based provider to be deployed to the implementing device 102. The network interface 106 may transmit encrypted data to the implementing device 102 for implementing and verifying the integrity of a trained model. For example, the network interface 106 may transmit encrypted input output pairs to the implementing device 102 so that the implementing device 102 can verify that an obtained model has not been tampered with and/or verify that the obtained model is not corrupted. Additionally, the network interface 106 may obtain a trained model via the network 114.

The implementing device 102 of FIG. 1 is a computing device (e.g., a computer, a server, etc.) that obtains a trained model. The implementing device 102 includes the network interface 108 to obtain data via the network 114. For example, the network interface 108 may obtain a trained model from a cloud service provider and/or may obtain encrypted input output pairs that can be used to verify the integrity of the trained model.

The TEE 110 of FIG. 1 is a trusted execution environment. The TEE 110 allows users to avoid sharing information, such as AI-based models, with cloud service providers. The TEE 110 provides confidentiality and integrity by lifting code and data into protected memory regions of the implementing device 102. As used herein a protected memory region is referred to as an enclave. The TEE 110 can be a process-based TEE, a virtual machine (VM)-based TEE, a GPU TEE, and/or any other environment that is separate, secure, and/or trusted within the implementing device 102. The TEE 110 is separate from the operating system of the implementing device 102 and uses encryption to protect data used by the TEE 110. In this manner, the TEE 110 can protect data and/or code from being tampered with or read by other code implemented by the operating system of the implementing device 102.

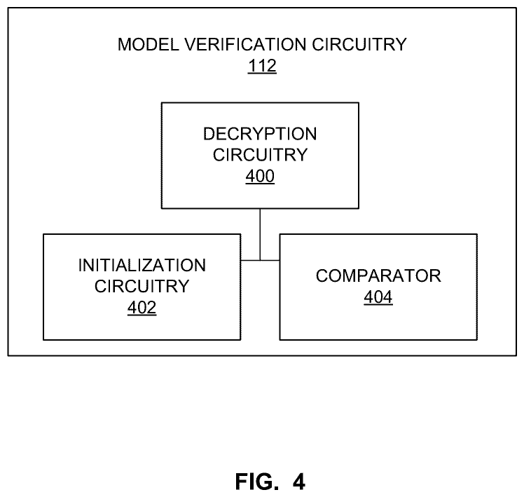

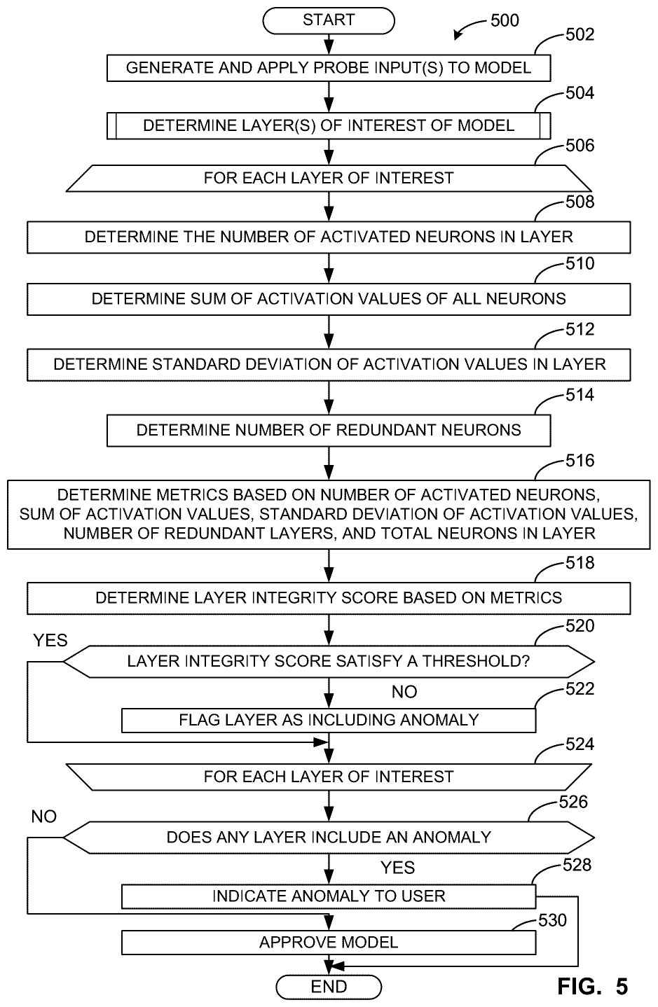

The TEE 110 of FIG. 1 includes model verification circuitry 112 to implement and verify an AI-based model obtained via the network interface 108. The model verification circuitry 112 can verify and load a security manifest of the TEE for facilitating TEE use by providing abstractions for measuring and building trusted applications and inputs. The security manifest may be a text file that includes configuration information, such as the names of code binaries that will be loaded into a software framework (SWF). The loaded binaries may include at least the SWF and AI runtime as well as other libraries. The model verification circuitry 112 can also verify and load AI runtime. AI runtime is software that allows a program to interact with computing resources needed to implement a trained AI-based model. Additionally, the model verification circuitry 112 decrypts the encrypted input output pairs and applies the input(s) to an obtained model to generate corresponding outputs(s). After generating the output(s), the model verification circuitry 112 compares the generated output(s) to the corresponding reference output(s) to determine if they match. If the output(s) and reference output(s) match, the model has not been corrupted or tampered with. If the output(s) and reference output(s) do not match, the model has been corrupted or tampered with. Accordingly, the model verification circuitry 112 can verify the integrity of an obtained model based on the comparations of the generated outputs to the reference outputs. The model verification circuitry 112 is further described below in conjunction with FIG. 4.

The example network 114 of FIG. 1 is a system of interconnected systems exchanging data. The example network 114 may be implemented using any type of public or private network such as, but not limited to, the Internet, a telephone network, a local area network (LAN), a cable network, and/or a wireless network. To enable communication via the network 114, the example devices 101, 102 may include a communication interface that enables a connection to an Ethernet, a digital subscriber line (DSL), a telephone line, a coaxial cable, or any wireless connection, etc. In some examples, the example devices 101, 102 are connected via the example network 114.

FIG. 2 is a block diagram of an example implementation of the integrity checking circuitry 103 of FIG. 1 to perform a layer-based integrity checking protocol. The integrity checking circuitry 103 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the integrity checking circuitry 103 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The integrity checking circuitry 103 of FIG. 2 includes example probe generation circuitry 200, an example AI-based model 202, example model metric determination circuitry 204, an example comparator 206, example storage 208, and an example user interface 210.

The probe generation circuitry 200 of FIG. 2 generates a probe (e.g., input data) that can be applied as an input into the AI-based model 202. The probe generation circuitry 200 can generate the probe randomly and/or based on a template. In some examples, the probe generation circuitry 200 can generate probes based on coverage maps to generate effective layer specific probes so that probe inputs do not lead to unintentional activation in other layers. The probe generation circuitry 200 inputs the probe into the AI-based model 202. In some examples, the probe generation circuitry 200 is instantiated by programmable circuitry executing model input generation circuitry instructions and/or configured to perform operations such as those represented by the flowchart(s) of FIGS. 5 and/or 6.

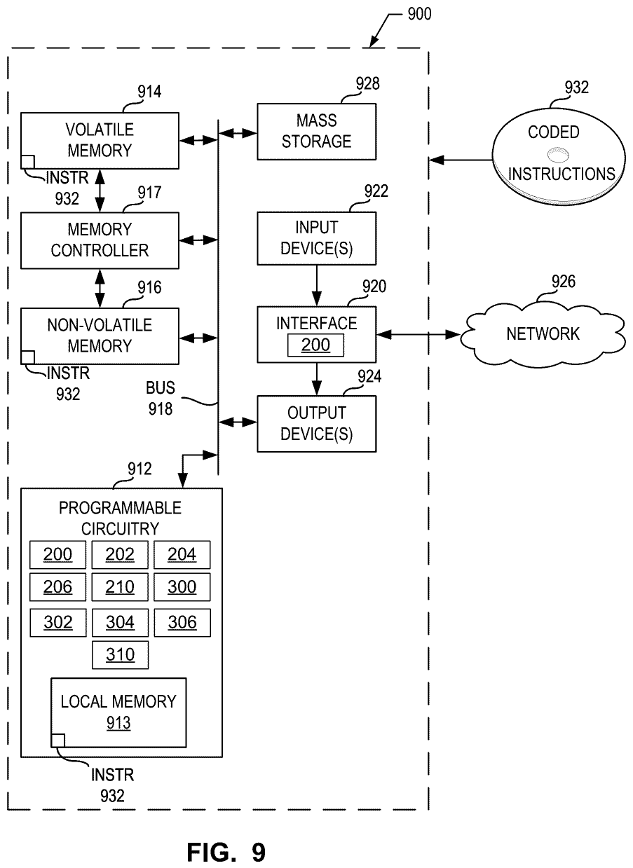

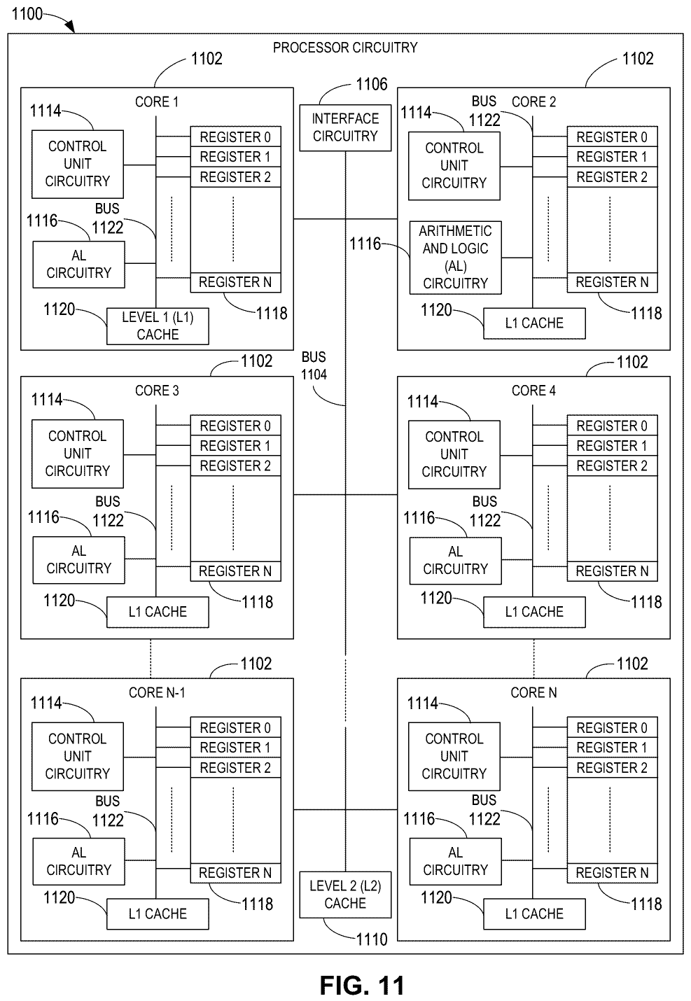

In some examples, the integrity checking circuitry 103 includes means for generating and applying a probe. For example, the means for generating and/or applying a probe may be implemented by the probe generation circuitry 200. In some examples, the probe generation circuitry 200 may be instantiated by programmable circuitry such as the example programmable circuitry 912, 1012 of FIGS. 9 and/or 10. For instance, the probe generation circuitry 200 may be instantiated by the example microprocessor 900 of FIG. 9 executing machine executable instructions such as those implemented by at least blocks 502 of FIG. 5. In some examples, the probe generation circuitry 200 be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the probe generation circuitry 200 may be instantiated by any other combination of hardware, software, and/or firmware. For example, the probe generation circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The AI-based model 202 of FIG. 2 is an AI-based model that has been trained to perform a specific task(s) (e.g., output generation, classification, grouping, etc.). The AI-based model 202 may be a machine learning model, a classification model, a deep neural network, a large language model, and/or any other type of AI-based model. The integrity checking circuitry 103 the integrity of the AI-based model 202 after training using layer-based integrity protocol (e.g., after/during training and/or before deployment). In some examples, the AI-based model 202 is instantiated by programmable circuitry executing model input generation circuitry instructions and/or configured to perform operations such as those represented by the flowchart(s) of FIGS. 5 and/or 6.

In some examples, the integrity checking circuitry 103 includes, means to generating an output. For example, the means for generating an output may be implemented by the AI-based model 202. In some examples, the AI-based model 202 may be instantiated by programmable circuitry such as the example programmable circuitry 912, 1012 of FIGS. 9 and/or 10. For instance, the AI-based model 202 may be instantiated by the example microprocessor 900 of FIG. 9 executing machine executable instructions such as those implemented by at least block 502 of FIG. 5. In some examples, the AI-based model 202 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the AI-based model 202 may be instantiated by any other combination of hardware, software, and/or firmware. For example, the AI-based model 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The model metric determination circuitry 204 of FIG. 2 determines various layer-specific characteristics of the AI-based model 202 based on the structure of the AI-based model 202 and/or the layer-specific operation characteristics of the AI-based model 202. For example, the model metric determination circuitry 204 determines a layer integrity score for each of the layers of the AI-based model 202 based on activation data of each layer. As described above, activation data relates to output data of a particular layer. The layer integrity score is based on a layer activation coverage value, a maximum activation intensity value, an activation spread metric value, and a layer activation coverage value. The model metric determination circuitry 204 determines the layer activation coverage (LAC) value for each layer of the AI-based model 202 using the below-Equation 1.

$$L A C = \frac{N umber of activated nuerons in a layer}{Total neurons in the layer} \qquad ( Equation 1 )$$

Accordingly, for each layer, when a probe or input is applied to the layer, the model metric determination circuitry 204 determines the number of activated neurons for the layer and determines the total neurons in the layer to determine the LAC. The model metric determination circuitry 204 can access the total neurons in the layer by accessing the value in the storage 208. The model metric determination circuitry 204 determines the maximum activation intensity (MAIavg) value for each layer of the AI-based model 202 using the below Equation 2.

$$M A {I}_{a v g} = \frac{\begin{matrix}Sum of the activation \\ values of all neurons in a layer\end{matrix}}{Total neurons in the layer} \qquad ( Equation 2 )$$

Accordingly, for each layer, when a probe or input is applied to the layer, the model metric determination circuitry 204 determines the sum of the activation values of all neurons in a layer and determines the total neurons in the layer to determine the MAIavg. The MAIavg is the highest activation value observed in a layer when subjected to the probe inputs. The model metric determination circuitry 204 determines the activation spread metric (ASM) value for each layer of the AI-based model 202 using the below Equation 3.

$$A S M = Standard deviation of the activation values in the layer . \qquad ( Equation 3 )$$

Accordingly, for each layer, when a probe or input is applied to the layer, the model metric determination circuitry 204 determines the standard deviation of the activation values in the layer. The ASM corresponds to how uniformly the activations are spread across neurons in a layer. The model metric determination circuitry 204 determines the layer activation coverage (NRR) value for each layer of the AI-based model 202 using the below Equation 4.

$$NNR = \frac{N umber of redundant nerons}{Total neurons in the layer} \qquad ( Equation 4 )$$

Accordingly, for each layer, when a probe or input is applied to the layer, the model metric determination circuitry 204 determines the number of redundant neurons and determines the total neurons in the layer. The NNR corresponds to the percentage of neurons that produce nearly identical activations for a given set of probe inputs, which can indicate neurons are redundant or if there is overfitting. The model metric determination circuitry 204 determines the layer integrity score (LIS) using the below Equation 5.

$$L I S = {w}_{1} \cdot L A C + {w}_{2} \cdot M A {I}_{a v g} - {w}_{3} \cdot A S M - {w}_{4} \cdot NNR . \qquad ( Equation 5 )$$

In the above Equation 5, w₁, w₂, w₃, w₄ are weights that may be adjusted based model context (e.g., characteristics of the AI-based model 202). The characteristics of the AI-based model 202 may be stored in the example storage 208. In some examples, the model metric determination circuitry 204 adjusts the weights based on user feedback and/or regression techniques.

In some examples, the model metric determination circuitry 204 can reduce resources and speed of the integrity checking protocol by performing the integrity checking protocol using layers of interest instead of all the layers of the AI-based model 202. The model metric determination circuitry 204 determines the layers of interest by calculating the mean and standard deviation of the activation levels of each layer. An activation level is an output value generated by an activation function of a layer in a neural network. The model metric determination circuitry 204 identifies layers where activation levels are significantly above the mean (e.g., Aavg(layer)>μ+kσ, where k is based on the architecture of the AI-based model and/or the trained data distribution). The model metric determination circuitry 204 applies a clustering algorithm (e.g., K-means clustering, hierarchical clustering, etc.) to the activation patterns of the layers of the AI-based model 202. The model metric determination circuitry 204 identifies cluster that represent highly activated layers based on the distinctive activation characteristics with the dynamically identified high activation layers and applies the metrics corresponding to the below Equations 6-8.

$${P}_{r a t i o} ( layer ) = max ( Activation ( neurons ) ) \qquad ( Equation 6 )$$

$${V}_{ratio} ( layer ) = \frac{Number of significantly activated nerons}{{N}_{n e u r o n s} ( layer )} \cdot 100 \% \qquad ( Equation 7 )$$

$${C}_{c onsistency} ( layer ) = Similarity ( {A}_{c u r r e n t} ( layer ) , {A}_{historical} ( layer ) ) \qquad ( Equation 8 )$$

In the above Equations 6-8, Peak(layer) is the peak activation in the dynamic layers, Vratio(layer) is the dynamic utilization ratio, and Cconsistency(layer) is the activation pattern consistency score (e.g., consistence of activation patterns in the layers compared to historical data). For the above Equations 6-8, the model metric determination circuitry 204 determines the maximum activation level within the identified layers, the number of significantly activated neurons (e.g., based on the deviation from the mean activation level of the layer), and the similarity (e.g., using a cosine similarity, correlation, etc.). As further described below, the XX may verify the integrity of a model based on the metrics determined in the above Equations 6-8. The model metric determination circuitry 204 dynamically selects layers based on real-time analysis of the activation patterns of the AI-based model 202. The selected layers of interest play a role in the processing and decision making of the AI-based model 202. In some examples, the model metric determination circuitry 204 is instantiated by programmable circuitry executing model input generation circuitry instructions and/or configured to perform operations such as those represented by the flowchart(s) of FIGS. 5 and/or 6.

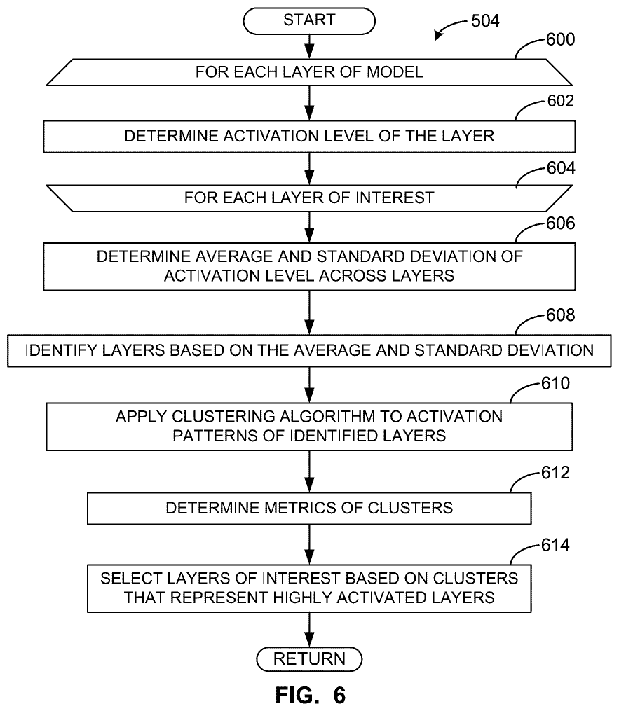

In some examples, the integrity checking circuitry 103 includes means for determining metrics of a model. For example, the means for determining metrics of a model may be implemented by the model metric determination circuitry 204. In some examples, the model metric determination circuitry 204 may be instantiated by programmable circuitry such as the example programmable circuitry 912, 1012 of FIGS. 9 and/or 10. For instance, the model metric determination circuitry 204 may be instantiated by the example microprocessor 900 of FIG. 9 executing machine executable instructions such as those implemented by at least blocks 504-518 and 522-530 of FIG. 5 and/or blocks 600-614 of FIG. 6. In some examples, the model metric determination circuitry 204 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the model metric determination circuitry 204 may be instantiated by any other combination of hardware, software, and/or firmware. For example, the model metric determination circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The comparator 206 of FIG. 2 accesses the determined LIS from the model metric determination circuitry 204 and a threshold, which may be stored in the storage 208. The comparator 206 compares the determined LIS to the threshold. If the comparator 206 determines that the determined LIS satisfies (e.g., is above) the threshold, the comparator 306 outputs a signal approving the integrity of the AI-based model 202. If the comparator determines that the determined LIS does not satisfy (e.g., is below) the threshold, the comparator 206 outputs a signal to not approve the integrity of the AI-based model 202 (e.g., indicating that the AI-model 202 is corrupt and/or includes an anomaly). If the comparator 206 does not approve of the AI-based model 202, the user interface 210 may output an indication to a developer that the AI-based model 202 is corrupted and/or may prevent the AI-based model 202 from being deployed. In some examples, the comparator 206 can compare the determined metrics from the above Equations 6-8 to corresponding thresholds. In such examples, if one or more of the metrics does not satisfy the corresponding threshold, the comparator 206 will output an indication that the AI-based model 202 has not been approved. Otherwise, the comparator 206 will output an indication that the AI-based model 202 has been approved. In some examples, the comparator 206 is instantiated by programmable circuitry executing model input generation circuitry instructions and/or configured to perform operations such as those represented by the flowchart(s) of FIGS. 5 and/or 6.

In some examples, the integrity checking circuitry 103 includes means for comparing. For example, the means for comparing may be implemented by the comparator 206. In some examples, the comparator 206 may be instantiated by programmable circuitry such as the example programmable circuitry 912, 1012 of FIGS. 9 and/or 10. For instance, the comparator 206 may be instantiated by the example microprocessor 900 of FIG. 9 executing machine executable instructions such as those implemented by at least blocks 522 of FIG. 5. In some examples, the comparator 206 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the comparator 206 may be instantiated by any other combination of hardware, software, and/or firmware. For example, the comparator 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The storage 208 of FIG. 2 stores threshold(s) and/or characteristics of the AI-based model 202 (e.g., number of layers, number of neurons in each layer, etc.). As described above, the comparator 206 and/or the model metric determination circuitry 204 accesses the threshold(s) and/or characteristics to determine the LIS score and/or determine if the LIS score satisfies a threshold.

In some examples, the integrity checking circuitry 103 includes means for storing. For example, the means for storing may be implemented by the storage 208. In some examples, the storage 208 may be instantiated by programmable circuitry such as the example programmable circuitry 912, 1012 of FIGS. 9 and/or 10. In some examples, the storage 208 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the storage 208 may be instantiated by any other combination of hardware, software, and/or firmware. For example, the storage 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate

The example user interface 210 of FIG. 2 interfaces with a user and/or developer. For example, the user interface 210 can indicate whether the integrity of the AI-based model 202 is verified and/or if the AI-based model 202 is corrupted and/or includes an anomaly based on the output of the comparator 206. In some examples, the user interface 210 is instantiated by programmable circuitry executing model input generation circuitry instructions and/or configured to perform operations such as those represented by the flowchart(s) of FIGS. 5 and/or 6.

In some examples, the integrity checking circuitry 103 includes means for displaying. For example, the means for displaying may be implemented by the user interface 210. In some examples, the user interface 210 may be instantiated by programmable circuitry such as the example programmable circuitry 912, 1012 of FIGS. 9 and/or 10. For instance, the user interface 210 may be instantiated by the example microprocessor 900 of FIG. 9 executing machine executable instructions such as those implemented by at least block 528 of FIG. 5. In some examples, the user interface 210 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the user interface 210 may be instantiated by any other combination of hardware, software, and/or firmware. For example, the user interface 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 3 is a block diagram of an example implementation of the model evaluation circuitry 104 of FIG. 1 to generate input output pairs to verify the integrity of an AI-based model. The model evaluation circuitry 104 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the model evaluation circuitry 104 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The model evaluation circuitry 104 of FIG. 3 includes example model input generation circuitry 300, an example AI-based model 302, example model analysis circuitry 304, an example comparator 306, example input output pair stage 308, and example encryption circuitry 310.

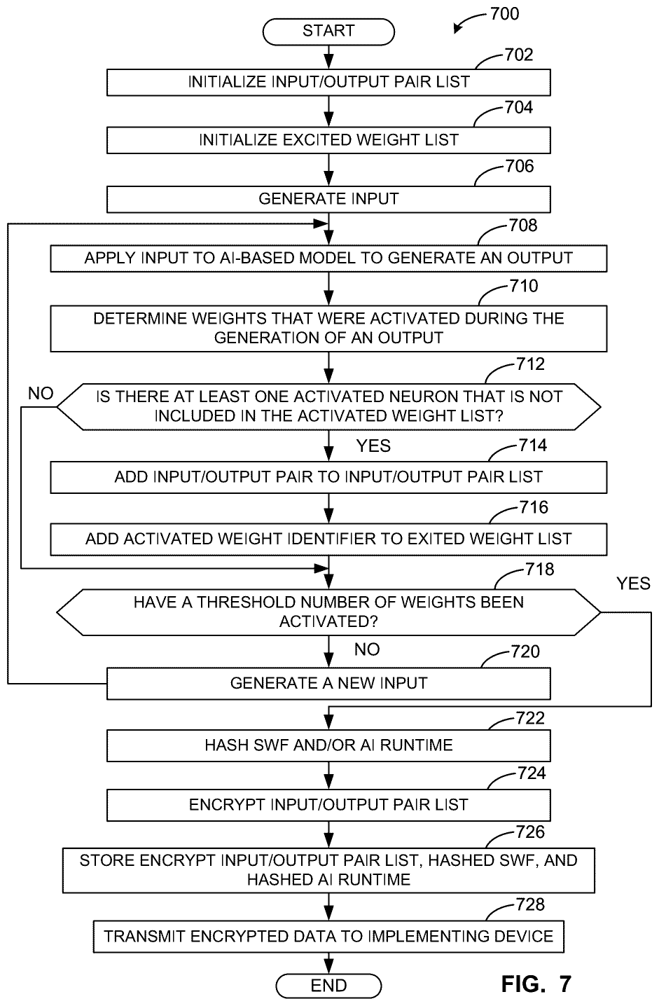

The model input generation circuitry 300 of FIG. 3 generates inputs that can be applied to the AI-based model 302 to generate input output pairs. The model input generation circuitry 300 could generate random inputs, obtain inputs from training data, and/or generate inputs based on results of previous application of previous inputs. After the model input generation circuitry 300 generates and/or obtains an input, the model input generation circuitry 300 applies the input to the AI-based model 302. In some examples, the model input generation circuitry 300 is instantiated by programmable circuitry executing model input generation circuitry instructions and/or configured to perform operations such as those represented by the flowchart(s) of FIG. 7.

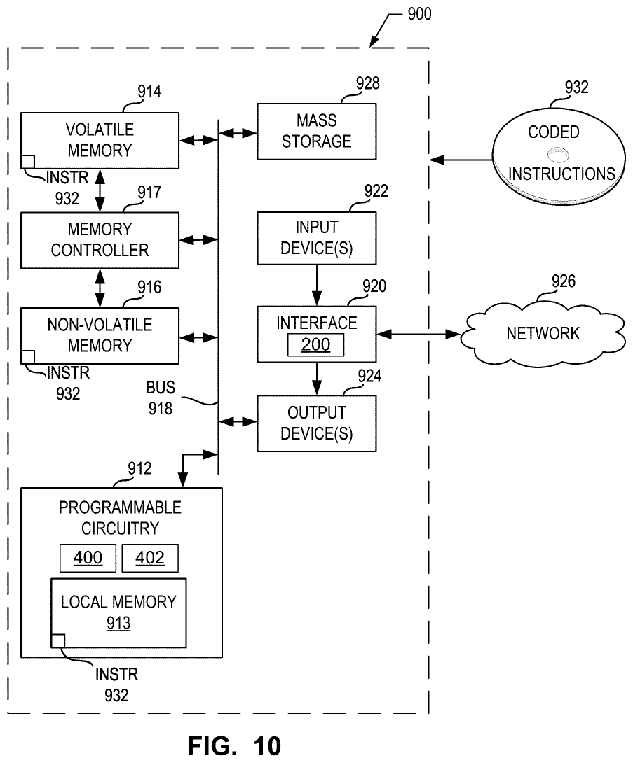

In some examples, the model evaluation circuitry 104 includes means for generating and/or applying an input to an AI-based model. For example, the means for generating and/or applying an input may be implemented by model input generation circuitry 300. In some examples, the model input generation circuitry 300 may be instantiated by programmable circuitry such as the example programmable circuitry 1012 of FIG. 10. For instance, the model input generation circuitry 300 may be instantiated by the example microprocessor 900 of FIG. 9 executing machine executable instructions such as those implemented by at least blocks 706 and 720 of FIG. 7. In some examples, the model input generation circuitry 300 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the model input generation circuitry 300 may be instantiated by any other combination of hardware, software, and/or firmware. For example, the model input generation circuitry 300 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The AI-based model 302 of FIG. 3 is an AI-based model that has been trained to perform one or more tasks. The AI-based model 302 may be a machine learning model, a classification model, a deep neural network, a large language model, and/or any other type of AI-based model. The AI-based model 302 may have been generated locally (e.g., by the client device 101 of FIG. 1) and/or trained by an external device and obtained via the network interface 106 of FIG. 1. The AI-based model 302 generates an output based on an applied input from the model input generation circuitry 300. The AI-based model 302 may include a number of layers of neurons that may or may not be excited (e.g., activated or fired) when data passes through the AI-based model 302. A neuron is excited, fired and/or activated, when an output value of a node is above a threshold, thereby sending the output data to a subsequent layer. When an input is applied to the AI-based model 302, a first group of neurons will be excited and a second group of neurons will not be excited when generating an output. In some examples, the AI-based model 302 is instantiated by programmable circuitry executing AI-based model instructions and/or configured to perform operations such as those represented by the flowchart(s) of FIG. 7.

In some examples, the model evaluation circuitry 104 includes means for generating an output. For example, the means for generating an output may be implemented by the AI-based model 302. In some examples, the AI-based model 302 may be instantiated by programmable circuitry such as the example programmable circuitry 1012 of FIG. 10. For instance, the AI-based model 302 may be instantiated by the example microprocessor 900 of FIG. 9 executing machine executable instructions such as those implemented by at least block 708 of FIG. 7. In some examples, the AI-based model 302 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the AI-based model 302 may be instantiated by any other combination of hardware, software, and/or firmware. For example, the AI-based model 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The model analysis circuitry 304 of FIG. 3 analyzes the AI-based model 302 when the outputs are generated based on applied inputs. For example, the model analysis circuitry 304 determines the neurons that were excited when a particular input was applied to the AI-based model 302. The model analysis circuitry 304 tracks the neurons that have been excited across multiple inputs using the comparator 306. For example, for each input, the model analysis circuitry 304 can determine which neurons were excited and the comparator 306 can compare the determined neurons to a list of previously excited neurons (e.g., an excited neuron list). For example, the model analysis circuitry 340 can determine a count of the number of non-zero activations (e.g., is_excited=activation>0). If the comparator 306 determines that a particular input excited a neuron that had not previously been excited, the model analysis circuitry 304 updates the excited neurons list and adds the input and corresponding output as an input output pair into the input output pair storage 308. If the comparator 306 determines that the excited neurons for a particular input are already included in the excited neuron list, the model analysis circuitry 304 discards the input and corresponding output. In some examples, the model analysis circuitry 304 is instantiated by programmable circuitry executing model analysis instructions and/or configured to perform operations such as those represented by the flowchart(s) of FIG. 7.

In some examples, the model evaluation circuitry 104 includes means for analyzing the AI-based model. For example, the means for analyzing the AI-based model may be implemented by the model analysis circuitry 304. In some examples, the model analysis circuitry 304 may be instantiated by programmable circuitry such as the example programmable circuitry 1012 of FIG. 10. For instance, the model analysis circuitry 304 may be instantiated by the example microprocessor 900 of FIG. 9 executing machine executable instructions such as those implemented by at least blocks 702, 704, 710, 714, and 716 of FIG. 7. In some examples, the model analysis circuitry 304 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the model analysis circuitry 304 may be instantiated by any other combination of hardware, software, and/or firmware. For example, the model analysis circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the model evaluation circuitry 104 includes means for comparing. For example, the means for comparing may be implemented by the comparator 306. In some examples, the comparator 306 may be instantiated by programmable circuitry such as the example programmable circuitry 1012 of FIG. 10. For instance, the comparator 306 may be instantiated by the example microprocessor 900 of FIG. 9 executing machine executable instructions such as those implemented by at least blocks 712, 718 of FIG. 7. In some examples, the model analysis circuitry 304 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the comparator 306 may be instantiated by any other combination of hardware, software, and/or firmware. For example, the comparator 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The model analysis circuitry 304 of FIG. 3 may instruct the model input generation circuitry 300 to continue to generate and apply additional input(s) to the AI-based model 302 until the excited neuron list is complete or substantially complete. For example, the model input generation circuitry 300 may stop instructing the model input generation circuitry 300 from generating and/or applying additional input(s) to the AI-based model 302 when all the neurons have been excited, when a threshold number of neurons has been excited, after a threshold duration of time, after a threshold number of inputs have been generated and/or applied, etc. Accordingly, the input output pair storage 308 represents the inputs and corresponding outputs that excite all or most of the neurons of the AI-based model 302. As further described above, the example network interface 106 can transmit the input output pair list to the implementing device 102 so that the implementing device 102 can verify the integrity of a locally implemented AI-based model corresponding to the AI-based model 302 to ensure that the AI-based model 302 has not been corrupted and/or tampered with. In some examples, the model analysis circuitry 304 is instantiated by programmable circuitry executing model analysis instructions and/or configured to perform operations such as those represented by the flowchart(s) of FIG. 7.

In some examples, the model evaluation circuitry 104 includes means for storing. For example, the means for storing may be implemented by the input output pair storage 308. In some examples, the input output pair storage 308 may be instantiated by programmable circuitry such as the example programmable circuitry 1012 of FIG. 10. For instance, the input output pair storage 308 may be instantiated by the example microprocessor 900 of FIG. 9 executing machine executable instructions such as those implemented by at least block 726 of FIG. 7. In some examples, the input output pair storage 308 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the input output pair storage 308 may be instantiated by any other combination of hardware, software, and/or firmware. For example, the input output pair storage 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The encryption circuitry 310 of FIG. 3 encrypts and/or hashes the set of input output pairs using any encryption and/or hashing technique. In this manner, the input output list is protected against attackers as it is transmitted via the network 114 of FIG. 1. Additionally, the encryption circuitry 310 can encrypt and/or hash an AI runtime and/or a software framework that can be used to implement the trained AI-based model. In some examples, the encryption circuitry 310 is instantiated by programmable circuitry executing encryption instructions and/or configured to perform operations such as those represented by the flowchart(s) of FIG. 7.

In some examples, the model evaluation circuitry 104 includes means for encrypting. For example, the means for encrypting may be implemented by the encryption circuitry 310. In some examples, the encryption circuitry 310 may be instantiated by programmable circuitry such as the example programmable circuitry 1012 of FIG. 10. For instance, the encryption circuitry 310 may be instantiated by the example microprocessor 900 of FIG. 9 executing machine executable instructions such as those implemented by at least blocks 722, 724 of FIG. 7. In some examples, the encryption circuitry 310 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the encryption circuitry 310 may be instantiated by any other combination of hardware, software, and/or firmware. For example, the encryption circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 4 is a block diagram of an example implementation of the model verification circuitry 112 of FIG. 1 to verify the integrity of an obtained AI-based model. The model evaluation circuitry 104 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the model evaluation circuitry 104 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The model verification circuitry 112 of FIG. 4 includes example decryption circuitry 400, example initialization circuitry 402, and an example comparator 404.

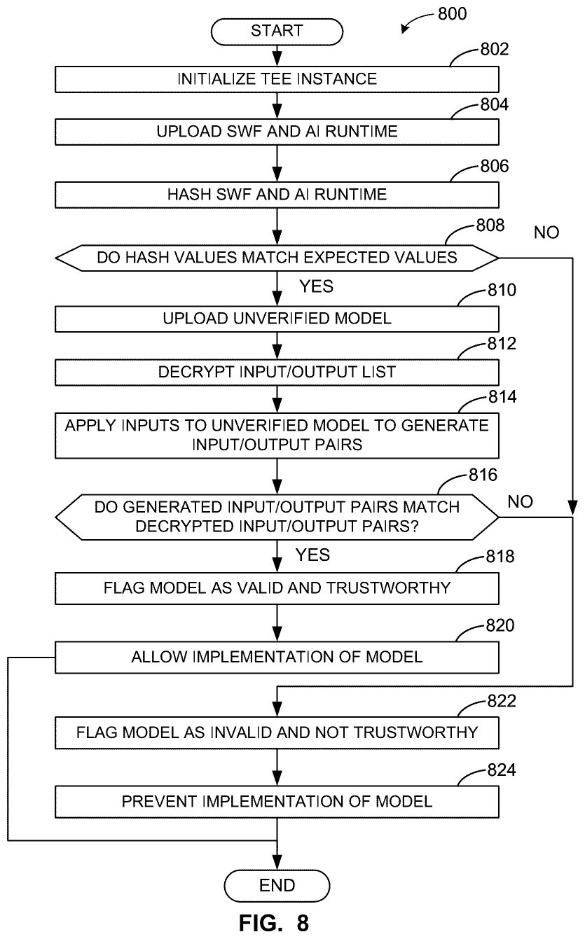

The decryption circuitry 400 of FIG. 4 decrypts and/or hashes the set of input output pairs using a decryption and/or hashing technique that corresponds to the encryption technique of the encryption circuitry 310 of FIG. 3. Additionally, the decryption circuitry 400 can decrypts and/or hash an AI runtime and/or a software framework that can be used to implement the trained AI-based model to determine if the hashed values correspond to expected values (e.g., to verify that the software framework and/or AI runtime is valid). In some examples, the decryption circuitry 400 is instantiated by programmable circuitry executing decryption instructions and/or configured to perform operations such as those represented by the flowchart(s) of FIG. 8.

In some examples, the model verification circuitry 112 includes means for decrypting. For example, the means for decrypting may be implemented by the decryption circuitry 400. In some examples, the decryption circuitry 400 may be instantiated by programmable circuitry such as the example programmable circuitry 1012 of FIG. 10. For instance, the decryption circuitry 400 may be instantiated by the example microprocessor 1000 of FIG. 10 executing machine executable instructions such as those implemented by at least blocks 802-824 of FIG. 8. In some examples, the decryption circuitry 400 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the decryption circuitry 400 may be instantiated by any other combination of hardware, software, and/or firmware. For example, the decryption circuitry 400 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The initialization circuitry 402 of FIG. 4 initializes a trained AI-based model to be implemented in the TEE 110 of FIG. 1. For example, the initialization circuitry 402 can load a software framework and/or an AI runtime into the TEE 110. Additionally, if the hash (e.g., hashing result) from the hashing of the software framework and/or an AI runtime match expected reference values, the initialization circuitry 402 loads an unverified AI-based model into the TEE 110. After the unverified AI-based model is loaded into the TEE 110, the initialization circuitry 402 applies inputs from the decrypted input output list into the unverified model and determines the corresponding output. The initialization circuitry 402 determines whether the AI-based model is legitimate or has been tampered with based on a comparison of the reference outputs of the input output list to corresponding outputs of the AI-based model. For example, if the reference outputs match the outputs of the AI-based model, the initialization circuitry 402 determines that the AI-based model is valid and/or trustworthy. However, if one or more of the reference outputs do not match the outputs of the AI-based model, the initialization circuitry 402 determines that the AI-based model is not valid or is untrustworthy and/or prevents implementation of the AI-based model. The initialization circuitry 402 outputs a validation result based on whether the AI-based model is trustworthy or untrustworthy. In some examples, the initialization circuitry 402 is instantiated by programmable circuitry executing initialization instructions and/or configured to perform operations such as those represented by the flowchart(s) of FIG. 8.

In some examples, the model verification circuitry 112 means for initializing. For example, the means for initializing may be implemented by the initialization circuitry 402. In some examples, the initialization circuitry 402 may be instantiated by programmable circuitry such as the example programmable circuitry 1012 of FIG. 10. For instance, the initialization circuitry 402 may be instantiated by the example microprocessor 1000 of FIG. 10 executing machine executable instructions such as those implemented by at least blocks 802-824 of FIG. 8. In some examples, the initialization circuitry 402 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the initialization circuitry 402 may be instantiated by any other combination of hardware, software, and/or firmware. For example, the initialization circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The comparator 404 of FIG. 1 compares outputs of an AI-based model to reference outputs of the input output pair list to determine if the outputs match. For example, if the input output pair list includes three input output pairs (e.g., I1/O1, I2/O2, and I3/O3), the initialization circuitry 402 will input I1, I2, and I3 into an AI-based model to generate O1′, O2′, and O3′, respectively. The comparator 404 compares O1 to O1′, o2 to O2′ and O3 to O3.′ If the outputs match, the comparator 404 indicates the match to the initialization circuitry 402. If one or more of the outputs do not match, the comparator 404 indicates the mismatch to the initialization circuitry 402. In some examples, the comparator 404 is instantiated by programmable circuitry executing comparator instructions and/or configured to perform operations such as those represented by the flowchart(s) of FIG. 8.

In some examples, the model verification circuitry 112 includes means for comparing. For example, means for comparing may be implemented by the comparator 404. In some examples, the comparator 404 may be instantiated by programmable circuitry such as the example programmable circuitry 1012 of FIG. 10. For instance, the comparator 404 may be instantiated by the example microprocessor 1000 of FIG. 10 executing machine executable instructions such as those implemented by at least blocks 802-824 of FIG. 8. In some examples, the comparator 404 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the comparator 404 may be instantiated by any other combination of hardware, software, and/or firmware. For example, the comparator 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the integrity checking circuitry 103, the model evaluation circuitry 104, and the model verification circuitry 112 of FIG. 1 is illustrated in FIGS. 2-4, one or more of the elements, processes, and/or devices illustrated in FIG. 2-4 may be combined, divided, re-arranged, omitted, eliminated, and/or implemented in any other way. Further, the probe generation circuitry 200, the AI-based model 202, the model metric circuitry 204, the comparator 206, the user interface 210, the model input generation circuitry 300, the AI-based model 302, the model analysis circuitry 304, the comparator 306, the encryption circuitry 310, the decryption circuitry 400, the initialization circuitry 402, and/or the comparator 404, and/or, more generally, the integrity checking circuitry 103, the model evaluation circuitry 104, and the model verification circuitry 112 of FIGS. 2-4, may be implemented by hardware alone or by hardware in combination with software and/or firmware. Thus, for example, any of the probe generation circuitry 200, the AI-based model 202, the model metric circuitry 204, the comparator 206, the user interface 210, the model input generation circuitry 300, the AI-based model 302, the model analysis circuitry 304, the comparator 306, the encryption circuitry 310, the decryption circuitry 400, the initialization circuitry 402, and/or the comparator 404, and/or, more generally, the integrity checking circuitry 103, the model evaluation circuitry 104, and the model verification circuitry 112 of FIGS. 2-4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the integrity checking circuitry 103, the model evaluation circuitry 104, and the model verification circuitry 112 of FIGS. 2-4 may include one or more elements, processes, and/or devices in addition to, or instead of, those illustrated in FIGS. 1-4, and/or may include more than one of any or all of the illustrated elements, processes, and devices.

Flowchart(s) representative of example machine-readable instructions, which may be executed by programmable circuitry to implement and/or instantiate the integrity checking circuitry 103, the model evaluation circuitry 104, and the model verification circuitry 112 of FIGS. 2-4 and/or representative of example operations which may be performed by programmable circuitry to implement and/or instantiate the integrity checking circuitry 103, the model evaluation circuitry 104, and the model verification circuitry 112 of FIGS. 2-4, is shown in FIGS. 5-8. The machine-readable instructions may be one or more executable programs or portion(s) of one or more executable programs for execution by programmable circuitry such as the programmable circuitry 912, 1012 shown in the example processor platform 900, 1000 discussed below in connection with FIGS. 9 and/or 10 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-8, many other methods of implementing the integrity checking circuitry 103, the model evaluation circuitry 104, and the model verification circuitry 112 of FIGS. 2-4 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, Go Lang, etc.

As mentioned above, the example operations of FIGS. 5-8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 5 is a flowchart representative of example machine-readable instructions and/or example operations 500 that may be executed, instantiated, and/or performed by programmable circuitry(ies) to train a perform a layer-based integrity checking protocol. For example, the example operations 500 may be executed, instantiated, and/or performed by the integrity checking circuitry 103 of FIG. 2. The example machine-readable instructions and/or the example operations 500 of FIG. 5 begin at block 502, at which the probe generation circuitry 200 generates a probe input(s) and applies the probe to the AI-based model 202.

At block 504, the integrity checking circuitry 103 determines layer(s) of interest of the AI-based model 202, as further described below in conjunction with FIG. 6. For each layer of interest (block 506-524), the model metric determination circuitry 204 determines the number of activated neurons in the layer when the probe was applied to the AI-based model 202 (block 508). At block 510, the model metric determination circuitry 204 determines a sum of the activation values of all the neurons for the layer. At block 512, the model metric determination circuitry 204 determines the standard deviation of the activation values in the layer. At block 514, the model metric determination circuitry 204 determines the number of redundant neurons in the layer.

At block 516, the model metric determination circuitry 204 determines metrics based on the number of activated neurons, the sum of the activation values, the standard deviation of the activation values, the number of redundant layers, and the total number of neurons in the layer (e.g., accessed from the storage 208 of FIG. 2). For example, the model metric determination circuitry 204 can determine the LAC, MAIavg, ASM, and NRR using the above Equations 1-4. At block 518, the model metric determination circuitry 204 determines the layer integrity score based on the metrics using the above-Equation 5.

At block 520, the comparator 206 determines if the layer integrity score satisfies a threshold. In some examples, the comparator 206 may also compare the metrics of the above Equations 6-8 to corresponding threshold to determine whether to flag a layer. If the comparator 206 determines that the layer integrity score satisfies the threshold (block 520: YES), control continues to block 524. If the comparator 206 determines that the layer integrity does not satisfy the threshold (block 520: NO), the model metric determination circuitry 204 flags the layer as including an anomaly (block 522).

After the layers of interest of the AI-based model 202 have been processed, the model metric determination circuitry 204 determines if any layer of interest included an anomaly, or a threshold number of anomalies. If the model metric determination circuitry 204 determines that one or more layers includes an anomaly (block 526: YES), the user interface 210 indicates the anomaly to a user and/or developer (block 528). If the model metric determination circuitry 204 determines that one or more layers does not include an anomaly (block 528: NO), the model metric determination circuitry 204 approves the integrity of the AI-based model 202 approves the AI-based model 202 for deployment (block 530).

FIG. 6 is a flowchart representative of example machine-readable instructions and/or example operations 504 that may be executed, instantiated, and/or performed by programmable circuitry(ies) to determine layer(s) of interest of the AI-based model 202. For example, the example operations 504 may be executed, instantiated, and/or performed by the integrity checking circuitry 103 of FIG. 2. The example machine-readable instructions and/or the example operations 504 of FIG. 6 begin by processing each layer of the AI-based model 202 (blocks 600-604), at which the model metric determination circuitry 204 determines the activation level of the layer of the AI-based model 202 (block 602).

After the activation levels of the layers of the AI-based model 202 are determined, the model metric determination circuitry 204 determines the average and standard deviation of the activation level(s) across the layers of the AI-based model 202 (606). At block 608, the model metric determination circuitry 204 identifies layers of interest based on the average and standard deviation (e.g., Aavg(layer)>μ+kσ, where k is based on the architecture of the AI-based model and/or the trained data distribution).

At block 610, the model metric determination circuitry 204 applies a clustering algorithm to the activation patterns of identified layers. At block 612, the model metric determination circuitry 204 determines metrics of the cluster. For example, the model metric determination circuitry 204 can determine peak activation in the dynamic layers, the dynamic utilization ratio, and/or the activation pattern consistency score using the above Equation 6-8. At block 614, the model metric determination circuitry 204 selects layers of interest based on clusters that represent highly activated layers. The model metric determination circuitry 204 can determine which clusters represent highly activated layers based on the distinction activation characteristics of the clusters.

FIG. 7 is a flowchart representative of example machine-readable instructions and/or example operations 700 that may be executed, instantiated, and/or performed by programmable circuitry(ies) to generate an input output pair list that can be used to verify an AI-based model. For example, the example operations 700 may be executed, instantiated, and/or performed by the model evaluation of FIG. 3. The example machine-readable instructions and/or the example operations 700 of FIG. 7 begin at block 702, at which the model analysis circuitry 304 initializes an input output pair list.

At block 704, the model analysis circuitry 304 initializes an excited weight list. At block 706, the model input generation circuitry 300 generates an input to apply to the AI-based model 302. The model input generation circuitry 300 may generate a random input or may generate an input based on results of a previous input. At block 708, the model input generation circuitry 300 applies the input to the AI-based model 302. After applied, the AI-based model 302 generates an output for the corresponding input. As further described above, a number of neurons in the AI-based model 302 will be excited to generate the output.

At block 710, the model analysis circuitry 304 determines which weights were activated (e.g., excited) during the generation of the output. In some examples, the model analysis circuitry 304 can determine which weights were activated by applying the same heuristic operation for any activation function based on activations greater than a threshold (e.g., 0). However, the model analysis circuitry 305 can identify activated weights using any technique known to those skilled in the art. At block 712, the comparator 306 determines if there is at least one activated neuron that is not included in the activated weight list. If the comparator 306 determines that there is not at least one activated neuron that is not included in the activated weight list (block 712: NO), control continues to block 718. If the comparator 306 determines that there is at least one activated neuron that is included in the activated weight list (block 712: YES), the model analysis circuitry 304 adds an input output pair to the input output pair list (block 714). At block 716, the model analysis circuitry 304 adds the activated weight identifiers to the excited weight list.

At block 718, the example model analysis circuitry 304 determines if a threshold number of weights has been activated. The threshold may be any number of the total weights of the AI-based model 302 based on user and/or manufacturer preferences. If the model analysis circuitry 304 determines that the threshold number of weights have not been activated (block 718: NO), the model input generation circuitry 300 generates a new input (block 720), and control returns to block 708 for another iteration. If the model analysis circuitry 304 determines that the threshold number of weights have activated (block 718: YES), the encryption circuitry 310 hashes a software framework (SWF) and/or AI runtime (block 722). In some examples, the encryption circuitry 310 may not hash the SWF. For example, the SWF may be available with its hash on a trustworthy public repository that can be downloaded by the implementing device 102. At block 724, the encryption circuitry 310 encrypts and/or hashes the input output pair list. In some examples, the encryption and/or hash of the input output pair list can be skipped. For example, encryption may be automatically performed at the transport network layer (e.g., via a TLS), as described above. At block 726, the input output pair list storage 308 stores the encrypted input output pair list, the hashed SWF, and/or the hashed AI runtime. At block 728, the example network interface 106 transmits the encrypted and/or hashed data to the implementing device 102 of FIG. 1 via the network 116.

FIG. 8 is a flowchart representative of example machine-readable instructions and/or example operations 800 that may be executed, instantiated, and/or performed by programmable circuitry(ies) to verify an obtained AI-based model. For example, the example operations 800 may be executed, instantiated, and/or performed by the model verification circuitry 112 of FIG. 4. The example machine-readable instructions and/or the example operations 800 of FIG. 8 begin at block 802, at which the operating system of the implementing device 102 initializes a TEE instance (e.g., the TEE 110 of FIG. 1).

At block 804, the initialization circuitry 402 uploads a received SWF and AI runtime that corresponds to an obtained AI-based model into the TEE 110. In some examples, the implementing device 102 may use a standard SWF that is available on the system. In some examples, the implementing device may obtain the SWF from a third part entity (e.g., such as the entity that provides the model. As described above, the TEE 110 can implement the SWF and/or the AI runtime to execute the AI-based model in the TEE 110. At block 806, the decryption circuitry 400 hashes the SWF and/or the AI runtime. The decryption circuitry 400 hashes the SWF and/or AI runtime to verify that SWF and/or AI runtime hasn't been tampered with. At block 808, the comparator 404 determines if the hashed values match expected values. If the comparator 404 determines that the hashed values do not match the expected values (block 808: NO), control continues to block 822. If the comparator 404 determines that the hashed values match the expected values (block 808: YES), the initialization circuitry 402 uploads the unverified model into the TEE 110 (block 810). For example, the initialization circuitry 402 may store the unverified model into temporary model until the model is verified. At block 812, the decryption circuitry 400 decrypts the input output list.

At block 814, the initialization circuitry 402 applies the inputs of the input output list to the unverified model to generate corresponding outputs. For example, the initialization circuitry 402 applies a first input I1 to the unverified model to generate a first output O1′, a second input I2 to the unverified model to generate a second output O2′, etc. At block 816, the comparator 404 determines if the generated outputs match the reference outputs from the decrypted input output pairs. For example, the comparator 404 determines if O1 matches O1′, O2 matches O2′, etc. If the comparator 404 determines that the generated outputs do not match the reference outputs (block 816: NO), control continues to block 822. If the comparator 404 determines that the generated outputs match the reference outputs (block 816: YES), the initialization circuitry 402 flags the model as valid and trustworthy (818). At block 820, the initialization circuitry 402 allows implementation of the model. In some examples, the initialization circuitry 402 allows the implementation of the model by storing the model in long term memory.

At block 822 (e.g., if the hash SWF and/or AI runtime are not as expected and/or if the generated output does not match the reference outputs), the initialization circuitry 402 flags the model as invalid and not trustworthy. At block 824, the initialization circuitry 402 prevents the implementation of the model. In some examples, the initialization circuitry 402 prevents the implementation of the model by preventing storage of the model in long term memory and/or discarding the uploaded model. Additionally, the TEE 110 may inform the client device 101 over a TLS connection with information related to a model flagged as invalid by transmitting a communication package over a network connection.

FIG. 9 is a block diagram of an example programmable circuitry platform 900 structured to execute and/or instantiate the example machine-readable instructions and/or the example operations of FIGS. 5-7 to implement the integrity checking circuitry 103 and/or the model evaluation circuitry 104 of FIGS. 1-3. The programmable circuitry platform 900 can be, for example, a server, a personal computer, a workstation, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry implements the probe generation circuitry 200, the AI-based model 202, the model metric circuitry 204, the comparator 206, the user interface 210, the model input generation circuitry 300, the AI-based model 302, the model analysis circuitry 304, the comparator 306, and/or the encryption circuitry 310.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916. Any one or more of the main memories 914, 916 or the local memory 913 can implement the storage 208, 308 of FIGS. 1 and/or 2.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, a keyboard, a button, a mouse, and/or a touchscreen.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIGS. 5-7, may be stored in the mass storage device 928, in the volatile memory 914, in the non-volatile memory 916, and/or on at least one non-transitory computer readable storage medium such as a CD or DVD which may be removable.

FIG. 10 is a block diagram of an example programmable circuitry platform 1000 structured to execute and/or instantiate the example machine-readable instructions and/or the example operations of FIG. 8 to implement the model verification circuitry 112 of FIGS. 1 and 4. The programmable circuitry platform 1000 can be, for example, a server, a personal computer, a workstation, a self-learning machine (e.g., a neural network), or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry implements the decryption circuitry 400, the initialization circuitry 402, and/or the comparator 404.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, a keyboard, a button, a mouse, and/or a touchscreen.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIG. 8, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 912, 1012 of FIGS. 9 and/or 10. In this example, the programmable circuitry 912, 1012 of FIGS. 9 and/or 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 5-8 to effectively instantiate the circuitry of FIGS. 1-4 as logic circuits to perform operations corresponding to those machine-readable instructions. In some such examples, the circuitry of FIGS. 11 and/or 12 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowchart of FIGS. 5-8.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. However, in some examples the L2 cache is connected to each core 1102 and the shared memory 1110 is implemented by level 3 (L3) cache for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 914, 916, 1014, 1016 of FIGS. 9-10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

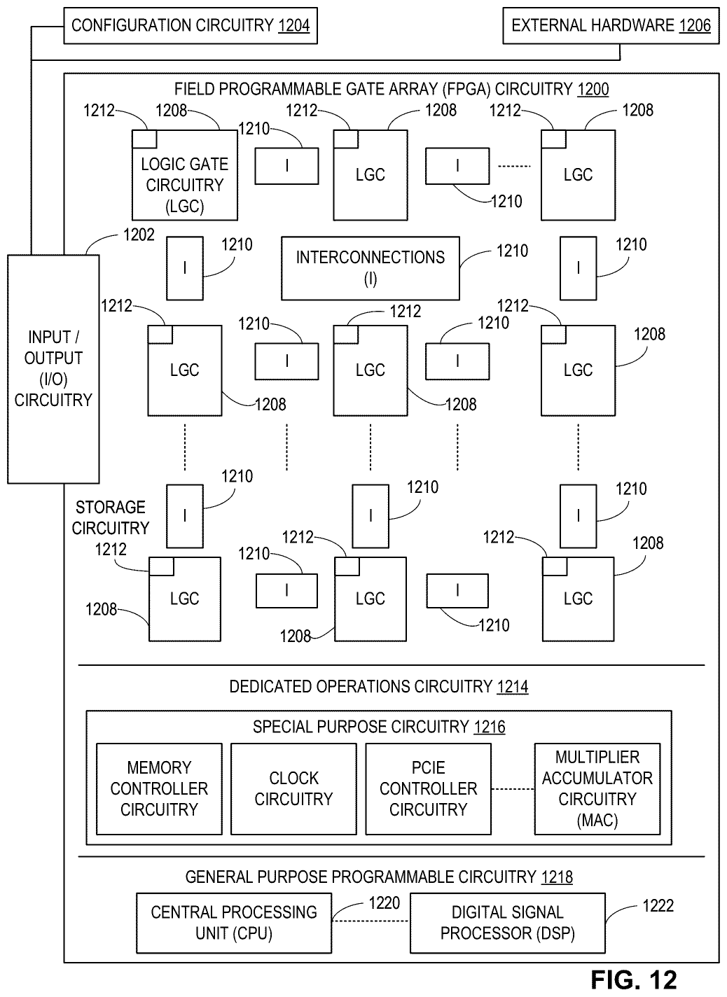

FIG. 12 is a block diagram of another example implementation of the programmable circuitry 912, 1012 of FIGS. 9 and/or 10. In this example, the programmable circuitry 912, 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 5-8 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-8. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-8. As such, the FPGA circuitry 1200 may be configured and/or structured to effectively instantiate some or all of the operations/functions corresponding to the machine-readable instructions of the flowchart(s) of FIGS. 5-8 as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 5-8 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 5-8 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 912, 1012 of FIGS. 9 and/or 10, many other approaches are contemplated. For example, FPGA circuitry may include an on-board CPU, such as one or more of the example CPU 1220 of FIG. 11. Therefore, the programmable circuitry 912, 1012 of FIGS. 9 and/or 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 5-8 to perform first operation(s)/function(s), the FPGA circuitry 1200 of FIG. 12 may be configured and/or structured to perform second operation(s)/function(s) corresponding to a second portion of the machine-readable instructions represented by the flowcharts of FIGS. 5-8, and/or an ASIC may be configured and/or structured to perform third operation(s)/function(s) corresponding to a third portion of the machine-readable instructions represented by the flowcharts of FIGS. 5-8.

It should be understood that some or all of the circuitry of FIGS. 11 and/or 12 may, thus, be instantiated at the same or different times. For example, the same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 11 and/or 12 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the processor circuitry 912, 1012 of FIGS. 11 and/or 12 may be implemented within one or more virtual machines and/or virtual execution environments executing on the microprocessor 1100 of FIG. 11.

In some examples, the programmable circuitry 912, 1012 of FIGS. 9 and/or 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 912, 1012 of FIGS. 9-10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

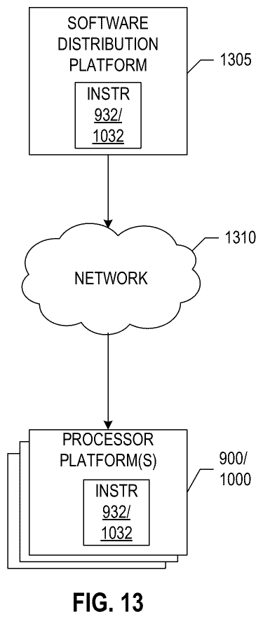

A block diagram illustrating an example software distribution platform 1305 to distribute software such as the example machine-readable instructions 932, 1032 of FIGS. 9 and/or 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 932, 1032 of FIGS. 9 and/or 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 932, 1032 which may correspond to the example machine-readable instructions of FIGS. 5-8, as described above. The one or more servers of the example software distribution platform 1305 are in communication with an example network 1310, which may correspond to the network 124 of FIG. 1. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 932, 1032 from the software distribution platform 1305. For example, the software, which may correspond to the example machine-readable instructions of FIGS. 5-8, may be downloaded to the example programmable circuitry platform 900, 1000 which is to execute the machine-readable instructions 932, 1032 to implement the processor circuitry 912, 1012. In some examples, one or more servers of the software distribution platform 1305 periodically offer, transmit, and/or force updates to the software (e.g., the example machine-readable instructions 932, 1032 of FIGS. 9 and/or 10) to ensure improvements, patches, updates, etc., are distributed and applied to the software at the end user devices. Although referred to as software above, the distributed “software” could alternatively be firmware.

Example methods, apparatus, systems, and articles of manufacture to design and test electronics using artificial intelligence are disclosed herein. Further examples and combinations thereof include the following:

Example 1 includes a non-transitory computer readable medium comprising instructions to cause at least one programmable circuit to initialize an instance of a trusted execution environment, upload a security manifest of the trusted execution environment and a machine learning model, determine whether to store the machine learning model into a memory based on checking of the security manifest, determine whether the machine learning model is valid, and output a validation result.

Example 2 includes the non-transitory computer readable medium of example 1, wherein the instructions cause the at least one programmable circuit to determine whether to store the machine learning model into the memory by hashing the security manifest to generate a hash result, and comparing the hashing to a reference value.

Example 3 includes the non-transitory computer readable medium of any one of examples 1-2, wherein the instructions cause the at least one programmable circuit to determine whether the machine learning model is valid by decrypting an input output list including a reference input value and a reference output value, and applying the reference input value to the machine learning model to generate a generated output value, and determining whether the machine learning model is valid based on a comparison of the generated output to the reference output value.

Example 4 includes the non-transitory computer readable medium of any one of examples 1-3, wherein the machine learning model is a first machine learning model, the instructions to cause the at least one programmable circuit to generate the input output list by applying the reference input value to a second machine learning model to generate the reference output value, the reference input value activating at least one neuron of the machine learning model not previously activated during an application of a previous reference input.

Example 5 includes a non-transitory computer readable medium comprising instructions to cause at least one programmable circuit to apply an input to an artificial intelligence (AI)-based model to generate an output, identify neurons of the AI-based model that were activated during the generation of the output, based on at least one identified neuron not being included in a first list add the at least one identified neuron to the first list, and add an input output pair to a second list, the input output pair identifying the input and the output, and transmit the second list to a device that accesses the AI-based model.

Example 6 includes the non-transitory computer readable medium of example 5, wherein the instructions cause the at least one programmable circuit to generate the input.

Example 7 includes the non-transitory computer readable medium of any one of examples 5-6, wherein the instructions cause the at least one programmable circuit to transmit the second list to the device based on the first list including a threshold number of identified neurons.

Example 8 includes the non-transitory computer readable medium of any one of examples 5-7, wherein the instructions cause the at least one programmable circuit to generate a new input when the first list has less than a threshold number of identified neurons.

Example 9 includes the non-transitory computer readable medium of any one of examples 5-8, wherein the input is a first input, the instructions to cause the at least one programmable circuit to apply a second input to the AI-based model, for a layer of the AI-based model, determine a metric based on activation values of the layer, and based on the metric not satisfying a threshold, flag the AI-based model as including an anomaly.

Example 10 includes the non-transitory computer readable medium of any one of examples 5-9, wherein the metric is based on at least one of a number of activated neurons for the layer, a sum of activation values, a standard deviation of activation values of the layer, or a number of redundant neurons.

Example 11 includes the non-transitory computer readable medium any one of examples 5-10, wherein the layer is a layer of interest.

Example 12 includes the non-transitory computer readable medium of any one of examples 5-11, wherein the instructions cause the at least one programmable circuit to determine that the layer is a layer of interest based on an average and standard deviation of activation level across layers of the model.

Example 13 includes a non-transitory computer readable medium comprising instructions to cause at least one programmable circuit to generate an input output pair list by applying reference inputs to a machine learning model to generate reference output values, and transmit the input output pair list to a device that has obtained to the machine learning model.

Example 14 includes the non-transitory computer readable medium of example 13, wherein the reference inputs, when applied to the machine learning model, excite more than a threshold number of neurons of the machine learning model.

Example 15 includes the non-transitory computer readable medium of any one of examples 13-14, wherein the instructions are to cause the at least one programmable circuit to generate the input output list by applying an input to an artificial intelligence-based model to generate an output, identifying neurons of the AI-based model that were activated during the generation of the output, and based on at least one identified neuron not being included in a first list adding the at least one identified neuron to the first list, and adding an input output pair to a second list, the input output pair identifying the input and the output.

Example 16 includes the non-transitory computer readable medium of any one of examples 13-15, wherein the instructions are to cause the at least one programmable circuit to load a machine learning (ML) model and the input output pair list into a trusted execution environment, the one or more pairs of the inputs and outputs including a reference input and a corresponding reference output, decrypt the input output pair list, select a reference input and a reference output from the input output pair list, apply the reference input of the input output list to the AI-based model to generate an output, compare the generated output to the reference output, and based on the generated output matching the reference output, flag the model as valid.

Example 17 includes the non-transitory computer readable medium of any one of examples 13-16, wherein the instructions are to cause the at least one programmable circuit to load a machine learning (ML) model and the input output pair list into a trusted execution environment, the one or more pairs of the inputs and outputs including a reference input and a corresponding reference output, decrypt the input output pair list, select a reference input and a reference output from the input output pair list, apply the reference input of the input output list to the AI-based model to generate an output, compare the generated output to the reference output, and based on the generated output mismatching the reference output, flag the model as invalid.

Example 18 includes the non-transitory computer readable medium of any one of examples 13-17, wherein the instructions to cause the at least one programmable circuit to apply an input to the AI-based model, for a layer of the AI-based model, determine a metric based on activation values of the layer, and based on the metric not satisfying a threshold, flag the AI-based model as including an anomaly.

Example 19 includes the non-transitory computer readable medium of any one of examples 13-18, wherein the metric is based on at least one of a number of activated neurons for the layer, a sum of activation values, a standard deviation of activation values of the layer, or a number of redundant neurons.

Example 20 includes the non-transitory computer readable medium of any one of examples 13-19, wherein the layer is a layer of interest.

From the foregoing, it will be appreciated that example systems, apparatus, articles of manufacture, and methods have been disclosed to design and test electronics using artificial intelligence. Examples disclosed check the integrity of a generated model using a layer-based integrity checking protocol. Additionally, examples disclosed herein utilize input output pairs to verify that an AI-based model has not been tampered with and/or corrupted. Examples disclosed herein protect the integrity of AI-based model using less resources than decryption techniques. Thus, the disclosed systems, apparatus, articles of manufacture, and methods are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A non-transitory computer readable medium comprising instructions to cause at least one programmable circuit to:
initialize an instance of a trusted execution environment;
upload a security manifest of the trusted execution environment and a machine learning model;
determine whether to store the machine learning model into a memory based on checking of the security manifest;
determine whether the machine learning model is valid; and
output a validation result.

2. The non-transitory computer readable medium of claim 1, wherein the instructions cause the at least one programmable circuit to determine whether to store the machine learning model into the memory by:
hashing code to generate a hash, the code including at least one of a software framework or an artificial intelligence runtime corresponding to the security manifest; and
comparing the hash to a reference value.

3. The non-transitory computer readable medium of claim 1, wherein the instructions cause the at least one programmable circuit to determine whether the machine learning model is valid by:
decrypting an input output list including a reference input value and a reference output value; and
applying the reference input value to the machine learning model to generate a generated output value; and
determining whether the machine learning model is valid based on a comparison of the generated output to the reference output value.

4. The non-transitory computer readable medium of claim 3, wherein the machine learning model is a first machine learning model, the instructions to cause the at least one programmable circuit to generate the input output list by applying the reference input value to a second machine learning model to generate the reference output value, the reference input value activating at least one neuron of the machine learning model not previously activated during an application of a previous reference input.

5. A non-transitory computer readable medium comprising instructions to cause at least one programmable circuit to:
apply an input to an artificial intelligence (AI)-based model to generate an output;
identify neurons of the AI-based model that were activated during the generation of the output;
based on at least one identified neuron not being included in a first list:
add the at least one identified neuron to the first list; and
add an input output pair to a second list, the input output pair identifying the input and the output; and
transmit the second list to a device that accesses the AI-based model.

6. The non-transitory computer readable medium of claim 5, wherein the instructions cause the at least one programmable circuit to generate the input.

7. The non-transitory computer readable medium of claim 5, wherein the instructions cause the at least one programmable circuit to transmit the second list to the device based on the first list including a threshold number of identified neurons.

8. The non-transitory computer readable medium of claim 5, wherein the instructions cause the at least one programmable circuit to generate a new input when the first list has less than a threshold number of identified neurons.

9. The non-transitory computer readable medium of claim 5, wherein the input is a first input, the instructions to cause the at least one programmable circuit to:
apply a second input to the AI-based model;
for a layer of the AI-based model, determine a metric based on activation values of the layer; and
based on the metric not satisfying a threshold, flag the AI-based model as including an anomaly.

10. The non-transitory computer readable medium of claim 9, wherein the metric is based on at least one of a number of activated neurons for the layer, a sum of activation values, a standard deviation of activation values of the layer, or a number of redundant neurons.

11. The non-transitory computer readable medium of claim 9, wherein the layer is a layer of interest.

12. The non-transitory computer readable medium of claim 11, wherein the instructions cause the at least one programmable circuit to determine that the layer is a layer of interest based on an average and standard deviation of activation level across layers of the model.

13. A non-transitory computer readable medium comprising instructions to cause at least one programmable circuit to:
generate an input output pair list by applying reference inputs to a machine learning model to generate reference output values;
transmit the input output pair list to a device that has obtained to the machine learning model.

14. The non-transitory computer readable medium of claim 13, wherein the reference inputs, when applied to the machine learning model, excite more than a threshold number of neurons of the machine learning model.

15. The non-transitory computer readable medium of claim 13, wherein the instructions are to cause the at least one programmable circuit to generate the input output list by:
applying an input to an artificial intelligence-based model to generate an output;
identifying neurons of the AI-based model that were activated during the generation of the output; and
based on at least one identified neuron not being included in a first list:
adding the at least one identified neuron to the first list; and
adding an input output pair to a second list, the input output pair identifying the input and the output.

16. The non-transitory computer readable medium of claim 13, wherein the instructions are to cause the at least one programmable circuit to:
load a machine learning (ML) model and the input output pair list into a trusted execution environment, the one or more pairs of the inputs and outputs including a reference input and a corresponding reference output;
select the reference input and the reference output from the input output pair list;
apply the reference input of the input output list to the AI-based model to generate an output;
compare the generated output to the reference output; and
based on the generated output matching the reference output, flag the model as valid.

17. The non-transitory computer readable medium of claim 13, wherein the instructions are to cause the at least one programmable circuit to:
load a machine learning (ML) model and the input output pair list into a trusted execution environment, the one or more pairs of the inputs and outputs including a reference input and a corresponding reference output;
decrypt the input output pair list;
select the reference input and the reference output from the input output pair list;
apply the reference input of the input output list to the AI-based model to generate an output;
compare the generated output to the reference output; and
based on the generated output mismatching the reference output, flag the model as invalid.

18. The non-transitory computer readable medium of claim 13, wherein the instructions to cause the at least one programmable circuit to:
apply an input to the AI-based model;
for a layer of the AI-based model, determine a metric based on activation values of the layer; and
based on the metric not satisfying a threshold, flag the AI-based model as including an anomaly.

19. The non-transitory computer readable medium of claim 18, wherein the metric is based on at least one of a number of activated neurons for the layer, a sum of activation values, a standard deviation of activation values of the layer, or a number of redundant neurons.

20. The non-transitory computer readable medium of claim 18, wherein the layer is a layer of interest.
